(19) United States
(12) Patent Application Publication
(10) Pub. No.: US 2011/0131147 A1
(43) Pub. Date: Jun. 2, 2011

(54) METHOD AND SYSTEM FOR RECOMMENDATION BASED ON LOCATIONAL AND SOCIETAL RELATION

(75) Inventors: Hoon-Ki LEE, Daejeon (KR); Jong-Hoon Lee, Daejeon (KR); Jung-Tae Kim, Daejeon (KR); Eui-Hyun Paik, Daejeon (KR)

(73) Assignee: Electronics and Telecommunications Research Institute, Daejeon (KR)

(21) Appl. No.: 12/944,239

(22) Filed: Nov. 11, 2010

(30) Foreign Application Priority Data
Nov. 30, 2009 (KR) 10-2009-0117334

(51) Int. Cl. G06Q 30/00

(52) U.S. Cl. 705/347

(57) ABSTRACT

The present invention provides a method and a system for recommendation based on locational and societal relation capable of providing more personalized information by being linked with other persons that have locational and societal relationship based on the behavior, value, preference of the user through a psychographics-based recommendation system.

### CROSS REFERENCE TO RELATED APPLICATIONS

This application claims priority to Korean Patent Application No. 10-2009-0117334 filed on Nov. 30, 2009, the entire contents of which are herein incorporated by reference.

### BACKGROUND OF THE INVENTION

1. Field of the Invention

The present invention relates to a method and a system for configuring recommendation based on locational and societal relation psychographics capable of overcoming restrictive elements of a social network service (SNS).

2. Description of the Related Art

Recently, by establishing a new service through the Internet as new business, a method for creating new profit by providing higher-quality contents service to users has been newly proposed. In a known contents recommendation service technology, the corresponding contents are limited to one product item such as books, album, etc. The contents recommendation service technology performs basic recommendation through prediction by analyzing tendency of a group rather than actually analyzing the preference information of each person.

As described above, in order to solve the problems where recommendation contents are determined regardless of a user and provided at any time, U.S. Pat. No. 653,917 discloses a contents recommendation service system that configures a preference file of a user for each contents field based on keywords and preference information for contents and uses the user preferred file that can select and recommend the user preferred contents from the recommendation candidate list to conform to a position on the web site of the user.

The recommendation system databases and provides a past history, an inquiry frequency, a purchase history as well as information on all the users accessing web sites providing a recommendation system as statistical information through online and uses them as a data for searching the recommended information.

The information is packaged as if it is accumulated by the users. However, the personal profile information used for recommending product is actually insignificant. As a result, the following same recommendation list may be provided based on the profile information of most users using the information.

In addition, the method for recommending contents causes a problem of transferring unnecessary information such as providing the previously determined recommendation contents in the situation where it cannot be associated with the information providing service based on the locational relationship of the user and the societal relationship that can recommend the contents or suggest the previously recommended ripple of the user.

In addition, the social network service (SNS) has been proposed as a method for optimally solving the problem through psychographics information based on the locational relationship, societal relationship, and psychological relationship of the user in order to provide knowledge or empirical information for the problem to which the user wants to resolve under the Internet environment.

However, most Internet-based SNS services provide information indiscriminately based on the simple information search or statistical information, such that it may lead to the increase in time and costs due to the problem of transferring unnecessary information caused by actually searching the user desired information.

### SUMMARY OF THE INVENTION

Therefore, the present invention proposes to solve the problems of the related art. It is an object of the present invention to provide a method and a system for recommendation based on locational and societal relation capable of providing more personalized information by being linked with other persons that have locational and societal relationship based on the behavior, value, preference of the user through a psychographics-based recommendation system.

In order to achieve the above object, according to an embodiment of the present invention, there is provided a method for recommendation based on locational and societal relation, including: registering user profile information including psychographics information based on behavior, value, and preference of a user and positional information based on positional recognition and specific location domain region of a user in a user information database; registering recommendation target profile information including basic information defining basic data of a recommendation target and psychographics information that determines characteristics of the recommendation target in a product information database; and inquiring positional information and psychographics information on the corresponding user in the user information database and the psychographics information of the product information database after processing the authentication of the user; and selecting the recommendation target list optimized for the corresponding user by using the inquired information and providing it the corresponding user.

The user profile information further includes at least one of the history information of the user and the relational information with other users having societal relationship.

The psychographics information configuring the user profile information and the psychographics information configuring the recommendation target profile information are numerically quantified for a plurality of characteristics, respectively.

The recommendation target is product information.

The recommendation target is search information.

The selecting the recommendation target list optimized for the corresponding user by using the inquired information and providing it to the corresponding user selects the optimized recommendation target list by matching the psychographics information of the user to the psychographics information of the recommendation target by a matching engine tool.

In order to achieve the above object, according to an another embodiment of the present invention, there is provided a system for recommendation based on locational and societal relation, including: a user information database that registers user profile information including psychographics information based on behavior, value, and preference of a user and positional information based on positional recognition and specific location domain region of a user; a product information database that registers recommendation target profile information including basic information defining basic data of a recommendation target and psychographics information that determines characteristics of the recommendation target; and a recommendation processor that inquires positional information and psychographics information on the corresponding user in the user information database and the psychographics information in the product information database after processing authentication of the user to select the recommendation target list optimized for the corresponding user and provides it to the corresponding user.

Preferably, the recommendation processor selects the optimized recommendation target list by matching the psychographics information of the user to the psychographics information of the recommendation target by a matching engine tool.

The user profile information further includes at least one of the history information of the user and the relational information with other users having societal relationship.

Preferably, the psychographics information configuring the user profile information and the psychographics information configuring the recommendation target profile information are numerically quantified for a plurality of characteristics, respectively.

The recommendation target may be product information and the recommendation target may be search information.

As set forth above, the present invention numerically represents the psychographics information based on behavior, value, and preference of the user and uses it at the time of recommending the personalized information or product provided to the user, thereby making it possible to more efficiently perform information search or product recommendation.

Further, the present invention can provide the optimal personalized information or the optimal product recommendation based on various information necessarily required for the user desired information search or product recommendation at the step of collecting the psychographics information while considering profile information, question, locational relationship, and societal relationship.

As a result, the present invention more efficiently performs the information providing service or the product recommendation service than the method for indiscriminately providing information, thereby making it possible to reduce the additional loss of time and costs.

### BRIEF DESCRIPTION OF THE DRAWINGS

FIG. 1 is a diagram showing a system for recommendation based on locational and societal relation according to an exemplary embodiment of the present invention;

FIG. 2 is a diagram showing an example of a user profile schema structure stored in a user information database shown in FIG. 1;

FIG. 3 is a diagram showing an example of a product profile schema structure stored in a product information database shown in FIG. 1; and

FIG. 4 is a flowchart showing a method for recommendation based on locational and societal relation according to a preferred embodiment of the present invention.

### DETAILED DESCRIPTION OF THE PREFERRED EMBODIMENTS

The present invention will be described below with reference to the accompanying drawings. Herein, the detailed description of a related known function or configuration that may make the purpose of the present invention unnecessarily ambiguous in describing the present invention will be omitted Exemplary embodiments of the present invention are provided so that those skilled in the art may more completely understand the present invention. Accordingly, the shape, the size, etc., of the elements in the figures may be exaggerated for explicit comprehension.

Hereinafter, a method and system for recommendation based on locational and societal relation according to an exemplary embodiment will be described in detail with reference to the accompanying drawings.

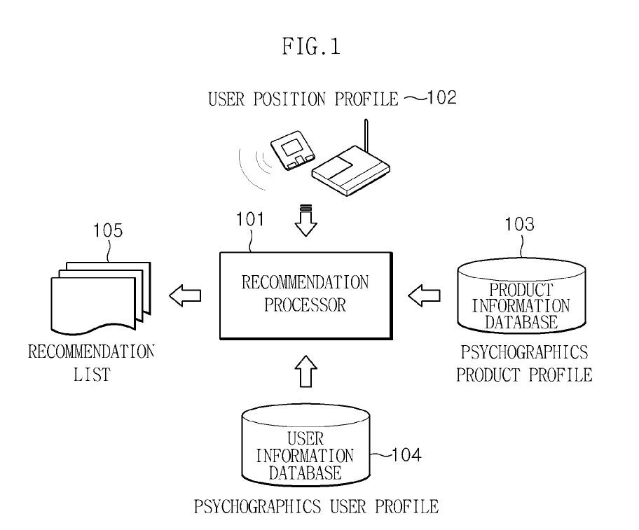

FIG. 1 is a system for recommendation based on locational and societal relation according to an exemplary embodiment of the present invention.

As shown in FIG. 1, a system for recommendation based on locational and societal relation includes a recommendation processor 101, a product information (recommendation target information) database 103, and a user information database 104.

In the present invention, the user information database 104 that configures the profile information of the user as an environmental element necessary to provide a recommendation list 105 to a user through the recommendation processor 101 based on psychographics is reconfigured by a method of numerically inputting the behavior, value, and preference of the user. The input method generally determines the preference of the user through a questionnaire and recognizes the behavior pattern through the positional information 102 of the user. Further, the past purchase history or relational information with other users having societal relationship is numerically reconfigured.

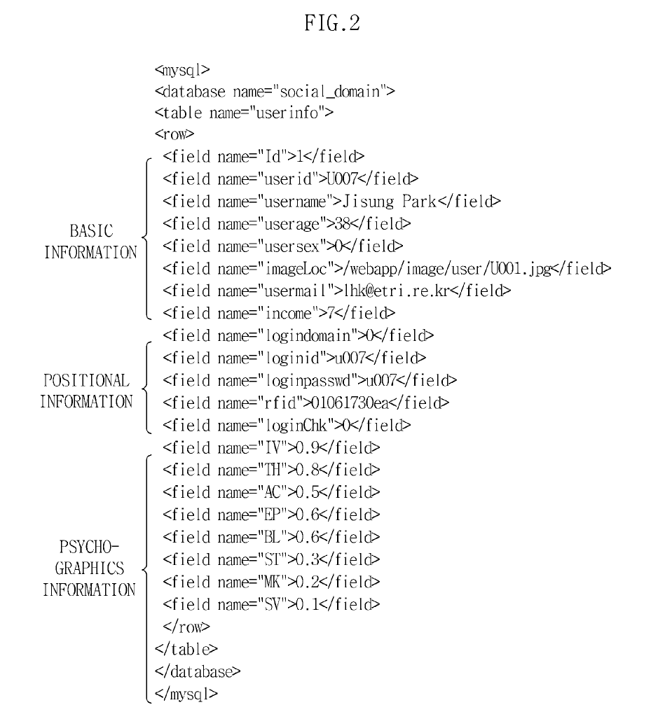

As described above, an example of the user profile schema structure registered in the user information database 104 may be configured as shown in FIG. 2. In other words, the user profile schema is configured to include a basic information field that is based on personal data, a positional information field for the positional recognition and the specific location domain region of the user, and a psychographics information field that manages psychographics information.

The basic information field configuring the user profile may include an identification information field, a user identification information field, a name field, an age field, a sex field, a photo field, an e-mail field, an income field, etc. In addition, the positional information field configuring the user profile may include a service domain information field, a log-in identifier information field, a log-in password, etc., which are accessed by the user.

Further, the psychographics information field may be defined as 8 fields, such as an innovator (IV) field, a thinker (TH) field, an achiever (AC) field, an experience (EP) field, a believer (BL) field, a striver (ST) field, a maker (MK) field, and a survivor (SV) field, which are quantified as a numerical value.

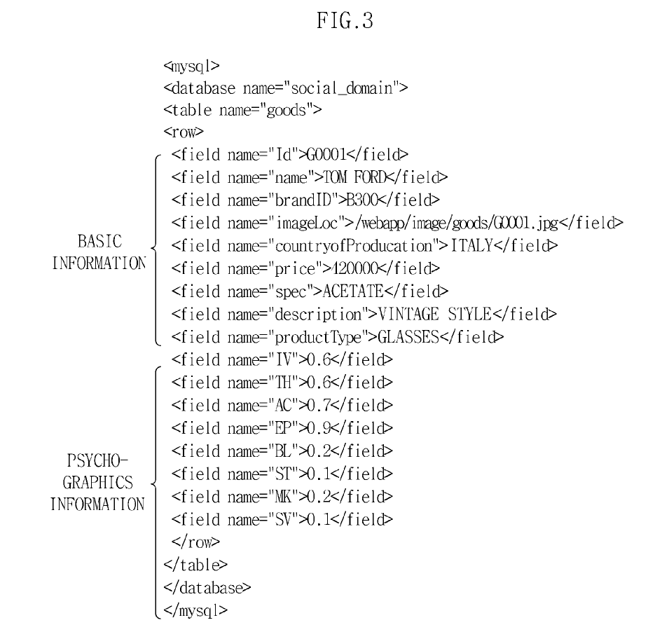

Meanwhile, an example of the product profile schema structure registered in the product information database 103 may be configured as shown in FIG. 3. In other words, the product profile schema is configured to include the basic information field that defines the basic data of the product and psychographics information that can determine the characteristics of the product.

The basic information of the product may include an identification information (ID) field, a maker field, a brand field, a photograph field, a price field, a material field, a product description field, a product name field, etc.

Further, the psychographics information of the product may be defined as 8 fields, such as an innovator (IV) field, a thinker (TH) field, an achiever (AC) field, an experience (EP) field, a believer (BL) field, a striver (ST) field, a maker (MK) field, and a survivor (SV) field, which each are quantified as a numerical value, thereby making it possible to recommend optimal products through affinity and similarity between the user and the product.

The recommendation system of the present invention is configured based on values attitudes and life styles (VALS). The VALS is based on needs hierarchy and societal characteristics.

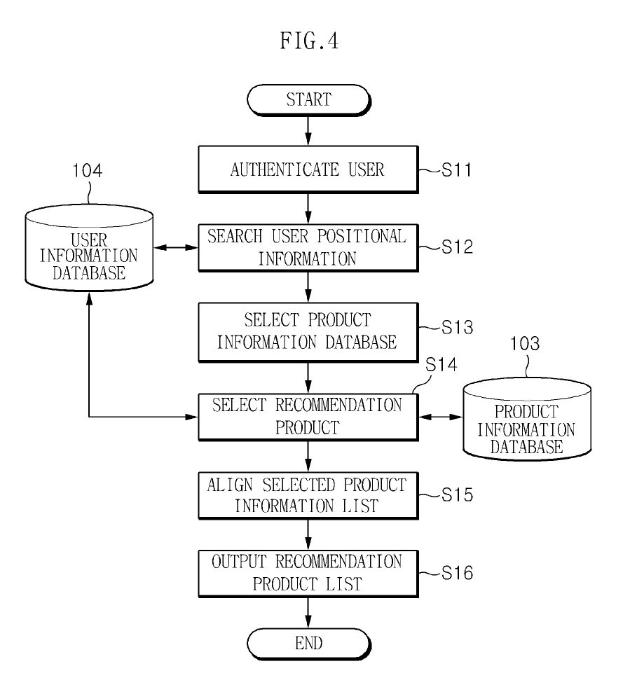

The recommendation system proposed in the present invention is configured to include 8 characteristics information, which can be appreciated in the psychographics information field of FIG. 3. The information is added to the recommendation processor 101 and is provided through a match engine tool (MET) that is an engine verifying similarity with the characteristic information of the product information. The operation of the recommendation processor 101 will be described in detail with reference to FIG. 4.

Although the present embodiment describes only the product information database 103, the present invention is not limited to the product but may provide the optimal personalized information by building the database such as other knowledge information, etc.

Next, the method for recommendation based on locational and societal relation according to the exemplary embodiment of the present invention will be described with reference to FIG. 4.

First, in order to use the recommendation system according to the present invention, the user recognizes the service subscribing condition at the location providing the recommendation service and requests the user authentication through the log-in procedure. Therefore, the recommendation processor 101 authenticates whether the corresponding user is a valid user (S11).

Thereafter, the recommendation processor 101 requests the search of the user positional information to the user information database 104 to inquire the user positional information (service domain, etc.) (S12) and the recommendation processor 101 recognizing the user positional information selects the product information database 103 (S13).

Then, the recommendation processor 101 searches the psychographics information on the corresponding user registered in the user information database 104 and the psychographics information field of the product information database 103 provided from the corresponding service domain and selects the recommendation product list optimized for the corresponding user through the matching engine tool (MET) (S14).

Thereafter, the recommendation processor 101 aligns and prepares the selected product information list (S15) and outputs the recommendation product list through the terminal of the corresponding user (S16).

Meanwhile, although the specific embodiment describes an example of recommending the product, the fact that the present invention is not limited thereto and can be applied to a case of recommending information can be easily understood by those skilled in the art.

As set forth above, the present invention numerically represents the psychographics information based on the behavior, value, and preference of the user and uses it at the time of recommending the personalized information or product provided to the user, thereby making it possible to more efficiently perform the information search or the product recommendation.

Further, the present invention can provide optimal personalized information or optimal product recommendation based on various information necessarily required for the user desired information search or product recommendation at the step of collecting the psychographics information while considering the profile information, question, locational relationship, and societal relationship.

As a result, the present invention more efficiently performs the information providing service or the product recommendation service than the method for indiscriminately providing information, thereby making it possible to reduce the additional loss of time and costs.

Some steps of the present invention can be implemented as a computer-readable code in a computer-readable recording medium. The computer-readable recording media include all types of recording apparatuses in which data that can be read by a computer system is stored. Examples of the computer-readable recording media include a ROM, a RAM, a CD-ROM, a CD-RW, a magnetic tape, a floppy disk, an HDD, an optical disk, an optical magnetic storage device, etc. and in addition, include a recording medium implemented in the form of a carrier wave (for example, transmission through the Internet). Further, the computer-readable recording media are distributed on computer systems connected through the network, and thus the computer-readable recording media may be stored and executed as the computer-readable code by a distribution scheme.

As described above, the exemplary embodiments have been described and illustrated in the drawings and the description. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A method for recommendation based on locational and societal relation, comprising:
registering user profile information including psychographics information based on behavior, value, and preference of a user and positional information based on positional recognition and specific location domain region of a user in a user information database;
registering recommendation target profile information including basic information defining basic data of a recommendation target and psychographics information that determines characteristics of the recommendation target in a product information database;
inquiring positional information and psychographics information on the corresponding user in the user information database and the psychographics information in the product information database after processing the authentication of the user; and
selecting the recommendation target list optimized for the corresponding user by using the inquired information and providing it to the corresponding user.

2. The method for recommendation based on locational and societal relation according to claim 1, wherein the user profile information further includes at least one of the history information of the user and the relational information with other users having societal relationship.

3. The method for recommendation based on locational and societal relation according to claim 1, wherein the psychographics information configuring the user profile information and the psychographics information configuring the recommendation target profile information are numerically quantified for a plurality of characteristics, respectively.

4. The method for recommendation based on locational and societal relation according to claim 1, wherein the recommendation target is product information.

5. The method for recommendation based on locational and societal relation according to claim 1, wherein the recommendation target is search information.

6. The method for recommendation based on locational and societal relation according to claim 1, wherein selecting the recommendation target list optimized for the corresponding user by using the inquired information and providing it to the corresponding user selects the optimized recommendation target list by matching the psychographics information on the user to the psychographics information on the recommendation target by a matching engine tools.

7. A system for recommendation based on locational and societal relation, comprising:
a user information database that registers user profile information including psychographics information based on behavior, value, and preference of a user and positional information based on positional recognition and specific location domain region of a user;
a product information database that registers recommendation target profile information including basic information defining basic data of a recommendation target and psychographics information that determines characteristics of the recommendation target; and
a recommendation processor that inquires positional information and psychographics information on the corresponding user in the user information database and the psychographics information in the product information database after processing the authentication of the user to select the recommendation target list optimized for the corresponding user and provides it to the corresponding user.

8. The system for recommendation based on locational and societal relation according to claim 7, wherein the user profile information further includes at least one of the history information of the user and the relational information with other users having societal relationship.

9. The system for recommendation based on locational and societal relation according to claim 7, wherein the psychographics information configuring the user profile information and the psychographics information configuring the recommendation target profile information are numerically quantified for a plurality of characteristics, respectively.

10. The system for recommendation based on locational and societal relation according to claim 8, wherein the recommendation target is product information.

11. The system for recommendation based on locational and societal relation according to claim 8, wherein the recommendation target is search information.

12. The system for recommendation based on locational and societal relation according to claim 8, wherein the recommendation processor selects the optimized recommendation target list by matching the psychographics information on the user to the psychographics information on the recommendation target by a matching engine tool.
